(19) United States
(12) Patent Application Publication
(10) Pub. No.: US 2007/0290399 A1
(43) Pub. Date: Dec. 20, 2007

(54) Handle and method of making thereof

(75) Inventors: Keith A. Easter, Kenosha, WI (US); Hua Gao, Fox Point, WI (US)

Correspondence Address: RYAN KROMHOLZ & MANION, S.C., POST OFFICE BOX 26618, MILWAUKEE, WI, 53226, US

(73) Assignee: Bradshaw Medical, Inc.

(21) Appl. No.: 11/471,307

(22) Filed: Jun. 20, 2006

(51) Int. Cl. B28B 5/00; B28B 7/22

(52) U.S. Cl. 264/255; 264/250

(57) ABSTRACT

A method of forming a composite handle for a medical device having a first step of forming an inside section of said handle that has at least one outwardly extending protrusion, and a second step of molding an outside section around the inside section. The two sections are made from different materials.

### BACKGROUND OF THE INVENTION

The present invention relates to medical equipment and devices and specifically to handles and grips for use with medical tools, drivers, and related equipment.

Drivers, wrenches, screwdrivers, and similar devices are used during medical procedures and surgical operations, such as during reconstruction of bone, spine, or similar bodily material. These devices are designed for both high precision and being able to deliver a high level of power or torque. Not only do the driving devices need to be precisely designed, but the handles must also be designed to insure a proper grip for the user that will stand up to the stress associated with using the device. That is, the handle should withstand the twisting and turning forces exerted on the handle when in use.

Prior art devices generally succumb to a few problems. First of all, the handles are relatively heavy when compared to the driving section of the tool. The tools, generally made of an aluminum or stainless steel material, are not necessarily evenly weight balanced, which is a disadvantage to the medical personnel using the tool. After an extended period of using such handles, the medical personnel may become fatigued, which is not desirous when performing surgery or other medical procedures.

Handles have been developed that are formed of two sections, with an outside section formed on the outside of an inside section, with each section generally being formed of separate materials. Such composite handles may also be formed of more than two sections. These handles can reduce the amount of heavy material needed for the handle by using a lighter material on the outside of the handle. While these handles reduced the weight compared to other prior art handles, they encounter problems with the outside section moving or slipping with respect to the first section. Both laterally and radially acting forces are in play with the outside section with respect to the inside section. Thus, the grip and useful life of the handle is reduced.

During surgical procedures, it may be necessary to take an x-ray while the tool is being used. Prior art handle designs can block the x-ray, which may limit the effectiveness of using an x-ray picture. Thus, an improved device would be preferably radiolucent, so as not to impede x-ray photographs and would be capable of stand up to the wear and tear delivered to the handle when in use. It would also be advantageous to develop a handle that was lighter than prior art handles and more evenly balanced, which would reduce fatigue and stress of the surgeon or medical personnel using the device.

### SUMMARY OF THE INVENTION

The present invention covers a method of forming a composite handle for a medical device or other tool, and the handle formed by the method. The method comprises a first step of forming an inside section of the handle that has at least one outwardly extending protrusion, and a second step of molding an outside section around the inside section. The protrusion or protrusions are designed to prevent lateral and axial movement of the outside section relative to the inside section. The inside section and the outside sections will be made from different materials, with the inside section preferably made from a plastic material and the outside section preferably formed of a silicon material.

The composite handle is designed for extended use without fatigue by the user. The handle is preferably radiolucent. These and other features will become evident from the drawings and the detailed description.

### BRIEF DESCRIPTION OF THE DRAWINGS

FIG. 1 is a perspective view of handle formed in accordance with the present invention.

FIG. 2 is a perspective view of the inside section of the handle of FIG. 1, having an outside section shown in phantom.

FIG. 3 is an elevated side view of the handle of FIG. 1.

FIG. 4 is a cross-sectional view of the handle of FIG. 1 taken along the line 4-4 of FIG. 3.

FIG. 5 is a cross-sectional view of the handle of FIG. 1 taken along the line 5-5 of FIG. 4.

FIG. 6 is a cross-sectional view of the handle of FIG. 1 taken along the line 6-6 of FIG. 4.

FIG. 7A is a side view of a prior art handle.

FIG. 7B is a side view of the handle of FIG. 7A being represented as viewed through an X-ray photograph.

FIG. 8A is a side view of a handle in accordance with the present invention.

FIG. 8B is a side view of the handle of FIG. 8A being represented as viewed through an X-ray photograph.

FIG. 9 is an alternate embodiment of an interior section formed in accordance with the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

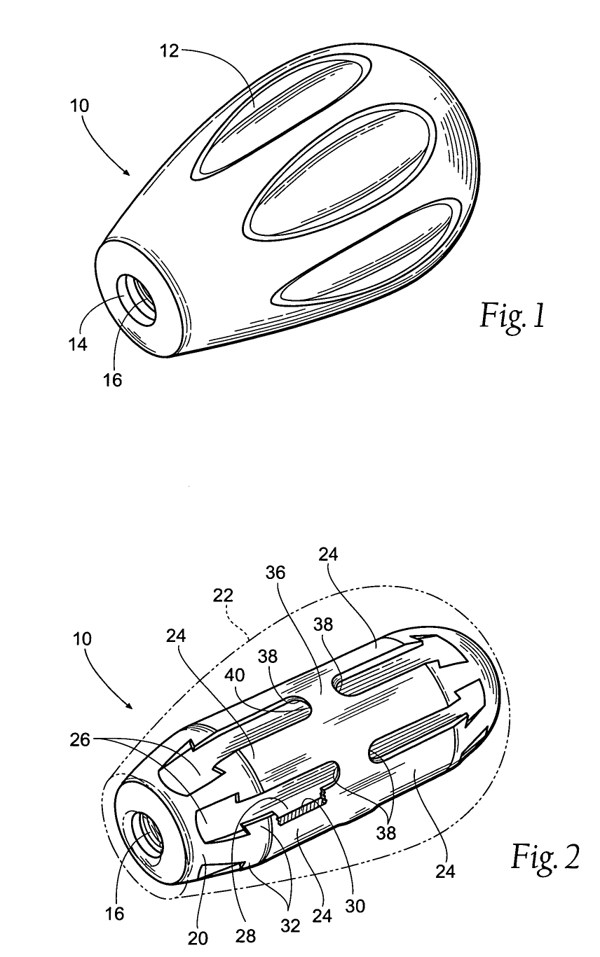

FIG. 1 is a perspective view of a handle 10 formed in accordance with the present invention. The handle 10 shown is exemplary of any shaped or designed handle and should not be considered as limiting as to the handle designs that could be included within the present invention. The handle 10 has an outside surface that has a gripping area 12 and an attachment area 14, which allows the handle to be connected to any of a variety of medical devices or other tools or drivers (not shown). The attachment area 14 as shown has a threaded surface 16, so that the handle 10 may be screwed together with a medical device. As stated regarding the shape and design of the handle, the attachment area 14 may be of any design that will allow coupling with a tool and should not be limited to the specific arrangement shown.

FIG. 2 provides a perspective view of the handle 10. The handle has an inside section 20 and an outside section 22, with the outside section 22 being shown in phantom. The inside section 20 and the outside sections 22 are formed separately and are formed of separate materials. Thus, the handle 10 can be considered a composite handle. The inside section 20 has a plurality of outwardly extending protrusions 24. The outside section 22 is molded onto the inside section 20. When the molding process is performed, preferably a transfer mold process as is known and used in the art, the outside section 22 will be secured to the inside section 20. The outside section 22 will not move or slip in relationship to the inside section 20, even when the handle 10 twists and is used to deliver high amounts of torque. The life of the handle 10 will be extended compared to prior art designs.

Referring further to FIG. 2, the inside section 20 is discussed in more detail. The inside section 20 has a base area 26, from which the protrusions 24 extend upwardly from. As is shown more clearly by way of a removed area 28, each of the protrusions 24 has a spine 30. The spine 30 terminates in a pair of edges 32, which generally extend outwardly and relatively perpendicular with respect to the spine 30. The edges 32 allow the inside section 20 to substantially grab and retain the outside section 22 when the outside section 24 is molded upon the inside section 20, which is necessary so that the outside section 22 does not slip or move when the handle 10 is being used. The shape of the inside section 22 is preferably machined to form the shown shape, but it is also possible to be formed in other manners, such as molding or other known processes. Also, it is understood that the spine 30 of the protrusions 24 could extend outwardly past the edges 32 and still fall within the scope of the present invention. That is, the protrusion 24 could form more of a cross-shaped design rather than the shown T-shaped design and still fall within the scope of the present invention. Provided that an inside section is formed that has a protrusion or protrusions that will grab and hold the outside section in place, the handle arrangement would fall within the scope of the present invention.

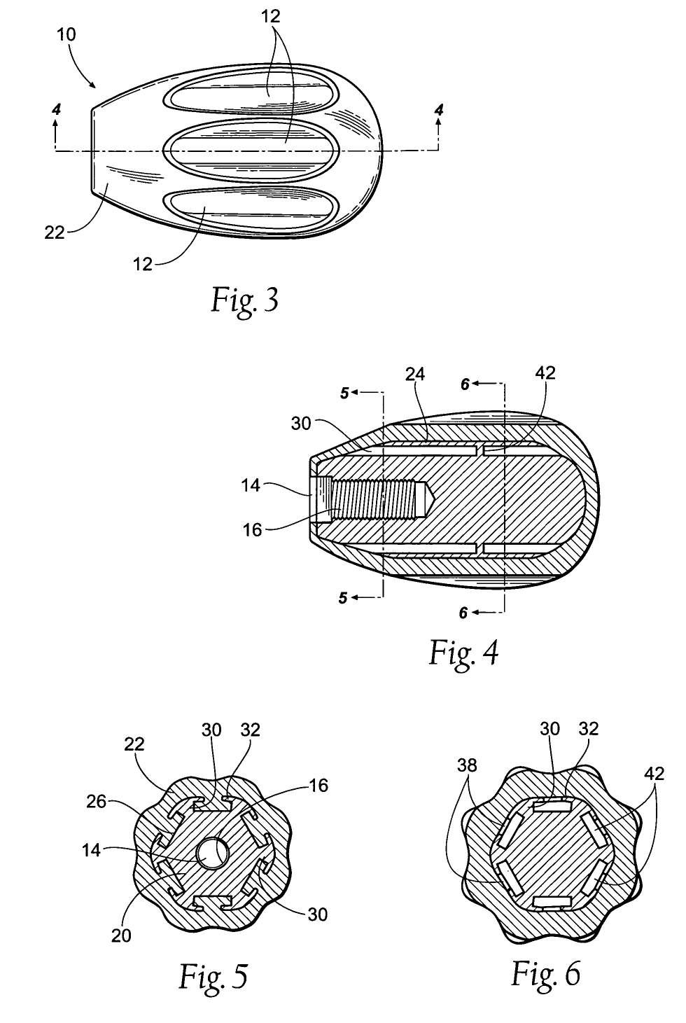

FIG. 3 provides a side view of the handle 10. As shown, the gripping section or sections 12 are preferably centrally aligned along the outside section 22. The handle 10 does not necessarily need specific gripping sections 12, but the sections 12 will provide an easier to grasp handle for the user. Any area that will improve the grasp of the used may be considered as gripping sections.

FIGS. 4-6 provide various sectional views of the handle 10. As shown in FIG. 4, the spines 30 of the protrusions 24 extend a substantially the lateral length of the inside section 20 and are preferably parallel to the horizontal axis of the handle 10. As FIG. 3 demonstrates, the protrusions 24 are generally connected to one another by way of a radial central section 36 that is integrally formed with or to the protrusions 24. The central section 36 itself could be considered a protrusion, as well. The described arrangement is preferred for increased stability of the inside section 20, but it is understood that the protrusions 24 may be arranged at other angles, lengths, or orientations and still fall within the scope of the present invention.

Referring again to FIG. 2, the radial central section 36 also contributes to securing the second section 22 to the inside section 20. Where the protrusions 24 intersect the central section 36, the central section 36 has a plurality of perimeter section 38 that extend outwardly from a central support 42 to form a plurality of flanges 40. The central support 42 can be seen in the sectional views of FIGS. 4 and 6. The flanges 40 further contribute to holding the outside section 22 in place and minimize any axial movement of the outside section 22. Thus, the outside section 22 is prevented from both radial and axial movement, which is a significant improvement over the prior art and leads to a longer useful life for the handle 10 compared to the prior art.

Referring more particularly to FIGS. 5 and 6, the protrusions 24 are symmetrically aligned around the attachment area 14. While it is not necessary that the handle 10 has such an arrangement, the symmetrical arrangement is preferable for overall balance and stability for the handle 10. Likewise, the symmetrical arrangement is easier to machine and form. The edges 32 are shown extending outwardly from the respective spines 30, which forms the sufficient area for the protrusions 24 to hold and secure the outside section 22 in place. As previously stated, there may be more or fewer protrusions 24 having differing shapes located on the inside section 20. Likewise, as previously stated, the central section 36 should also be considered a protrusion according to the present invention. Provided that the inside section 20 will secure the outside section 22 in place and prevent radial and axial movement of the outside section 22 with respect to the inside section 20, the design would fall within the scope of the present invention. Likewise, reference to a lip, flange, or edge, as discussed with respect edges 32 or the flanges 40, should be considered broadly to include all structures that extend outwardly to further prevent movement of an outside section.

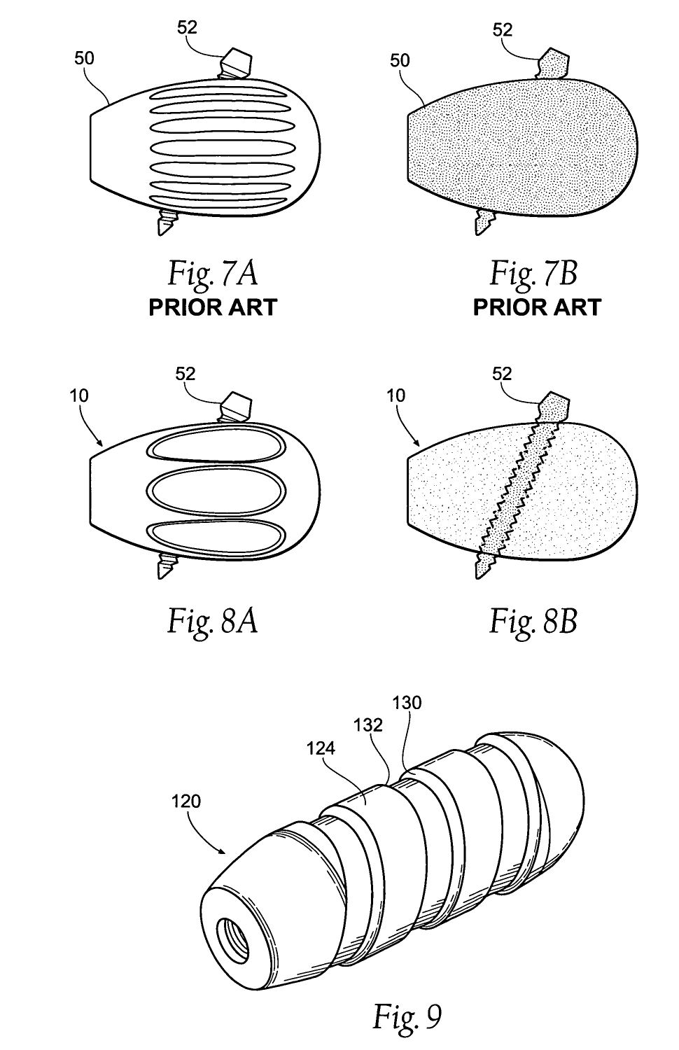

FIGS. 7A-8B further note the improvements of the present invention. Prior art composite handles 50 are made of aluminum or stainless steel as one or both of the separate sections of the handle, and possibly silicon used to form the outside section. However, as FIG. 7B demonstrates, such a handle 50 does not allow viewing of an instrument, bone, or other potential medically related object 52 through the handle 50 when the handle 50 is subjected to an x-ray.

The present invention allows for the instrument 52 to be viewed through the handle 10 when the handle is subjected to an X-ray. Often when a handle is in a specific position during surgery, the handle should not be moved until a specific procedure is performed. Thus, photographs may be taken where there is no choice but to have the handle in the photograph. The handle 10 increases the usefulness of such photos to allow a more accurate view of what is shown on the other side of the handle 10. The handle 10 is preferably made of a plastic inside section, such as Radel® or Ultem®, or other suitable plastics. The outside section is preferably made of silicon. While the inside section could be formed of aluminum or stainless steel, the use of a plastic contributes to the radiolucent qualities of the present invention and, also provides a lighter and more easily managed handle compared to the prior art. Furthermore, the ability to mold the silicon upon the plastic was not possible prior to the present invention. Prior processes did not contemplate ways for the outside section to be adequately secured to the inside section. Even providing the inside section with a roughened surface was not adequate to solidly secure the two sections together. Thus, the present invention provides a method of forming a composite handle having improved qualities over the prior art. Other qualities of the present handle include the fact that the handle may be autoclavable and reduce the hand fatigue of the person using the instrument.

FIG. 9 provides an alternate inside section 120. The inside section 120 has a single protrusion 124 that encircles the inside section 124, similar to the appearance of a barber pole. The protrusion 124 comprises a spine 130 with an extending edge 132, similar to the previously described protrusion 24 (see FIG. 2) in that it is designed to secure an outside section (not shown) to the inside section 120. FIG. 9 demonstrates that other embodiments of a protrusion are possible according to the present invention and the scope should not be limited to a single shape for an inside section.

Thus, the present invention provides a novel method for forming a composite handle, specifically used for medical equipment and procedures. Generally a first section is formed having at least one outwardly extending protrusion. The preferred method of forming the inside section is by machination process, but molding processes or other similar processes may be used. The inside section is then placed within a mold and the outside section is molded around the inside section, preferably by a transfer press mold method. The resultant handle 10 will withstand high values of torque, possibly over 130 p.s.i, without deforming. Besides the other improvements stated above, the present handle 10 generally has a longer useful life compared to the prior art.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A method of forming a composite handle for a medical device, said method comprising:
forming an inside section of said handle, said inside section having at least one outwardly extending protrusion, said inside section formed of a first material; and
molding an outside section around said inside section, said outside section being molded from a second material, said outside section being prevented from radial and axial movement by said protrusion.

2. The method of claim 1, wherein said step of molding is a transfer mold process.

3. The method of claim 1, wherein said second material is a silicon material.

4. The method of claim 1, wherein said formed handle is autoclavable.

5. The method of claim 1, wherein said formed inside section further comprising a plurality of outwardly extending protrusions, said outside section being prevented from radial and axial movement by said protrusions.

6. The method of claim 1, wherein said first material is a plastic material.

7. A method for manufacturing a composite handle for a medical device, said method comprising:
forming an inside section selected from a first material the group consisting of: stainless steel, aluminum, and plastic materials; and
molding an outside section around a portion thereof of said inside section, said outside section molded from a silicon material.

8. The method of claim 7, wherein said first material is a plastic material.

9. The method of claim 7, wherein said inside section further comprises an outwardly extending protrusion, said outwardly extending protrusion preventing radial and axial movement of said outside section with respect to said inside section.

10. The method of claim 9, wherein said inside section further comprises a plurality of outwardly extending protrusions, said outwardly extending protrusions preventing radial and axial movement of said outside section with respect to said inside section.

11. The method of claim 10, wherein said plurality of outwardly extending protrusions further comprise an extending edge, whereby at least a portion of said outside section being formed around said extending edge.

12. A method for manufacturing a composite handle for a medical device, said method comprising:
introducing a first material;
forming a first section from said first material, said first section including a first outwardly extending protrusion; and
placing said first section in a mold cavity;
introducing a second material into said mold cavity;
molding a second section from said second material around a portion thereof of said first section, whereby radial and axial movement of said outside section with respect to said inside section is prevented.

13. The method according to claim 12 wherein said first outwardly extended protrusion is substantially aligned along a lateral axis of said handle.

14. The method according to claim 12, wherein said second material is a silicon material.

15. The method according to claim 12, wherein said outwardly extending protrusion further comprises an extending edge, whereby at least a portion of said second section being formed around said extending edge.

16. The method according to claim 12, wherein said outwardly extending protrusion is substantially aligned along a radial axis of said handle.

17. The method according to claim 12, wherein said inside section comprises a second outwardly extending protrusion, said outwardly extended protrusion is substantially aligned along a lateral axis of said handle, said second protrusion intersecting said first protrusion.

18. The method according to claim 12, wherein said formed handle is radiolucent when viewed with an x-ray machine.

19. The method according to claim 12, wherein said first material is a plastic material.

20. The method according to claim 18, wherein said second material is a silicon material.
